(19) United States
(12) Patent Application Publication
(10) Pub. No.: US 2022/0234376 A1
(43) Pub. Date: Jul. 28, 2022

(54) METHOD FOR DIGITALLY PRINTING A PROFILED STRIP

(71) Applicant: Franz Neuhofer, Zell am Moos (AT)

(72) Inventor: Franz Neuhofer, Zell am Moos (AT)

(21) Appl. No.: 17/619,222

(22) PCT Filed: May 13, 2020
(86) PCT No.: PCT/AT2020/060198

§ 371 Date: Dec. 14, 2021

(30) Foreign Application Priority Data
Jul. 8, 2019 (AT) A50621/2019

(51) Int. Cl. B41J 25/308; B41J 3/54; B41J 11/00; B41J 25/00

(52) U.S. Cl. CPC B41J 25/3086; B41J 25/001; B41J 11/008; B41J 3/543

(57) ABSTRACT

The invention relates to a method for digitally printing a profiled strip (1) having a plurality of digital print heads (2) which are aligned with respect to contour portions (4, 5, 6) of the profiled strip (1) and are moved in this aligned reference position (a, b, c, d) relative to the profiled strip (1) along the longitudinal strips of the profiled strip determined by the contour portions (4, 5, 6) at a predetermined distance, wherein the nozzles of the print heads (2) are controlled with respect to the ink delivery as a function of a print template. In order to ensure advantageous method conditions, it is proposed that individual contour portions (4, 5, 6) are assigned reference planes (7) by an evaluation program on the basis of data reproducing the contour (3) of the profiled strip (1) in the printing area, in that the print heads (2) are aligned with respect to these reference planes (7), and in that the nozzles of the aligned print heads (2) are controlled with respect to the ink delivery with a correction value which takes into account the deviation of the respective contour portion (4, 5, 6) from the reference plane (7).

### FIELD OF THE INVENTION

The invention relates to a method for digitally printing a profiled strip with a plurality of digital print heads which are aligned with respect to contour portions of the profiled strip and are moved in this aligned reference position relative to the profiled strip along the longitudinal strips of the profiled strip determined by the contour portions at a predetermined distance, wherein the nozzles of the print heads are controlled with respect to the ink delivery as a function of a print template.

### DESCRIPTION OF THE PRIOR ART

For multicolor printing on a profiled strip with flat profiled surfaces, it is known (US 2001/0049010 A1) to provide a plurality of digital print heads which, by relative rotation of the print heads with respect to the profiled strip about an axis parallel to the longitudinal axis of the profiled strip, are aligned with respect to flat profiled surfaces in such a way that the nozzles, through which the ink droplets are applied in a metered manner to the profiled surfaces to be printed, are perpendicular to the profiled surface. After setting the distance of the print heads from the profiled surfaces assigned to them, the print heads can be moved uniformly in the longitudinal direction of the profiled strip relative to the profiled strip while maintaining the set distance, so that constant printing conditions are established over the length of the profiled strip for printing the individual profiled surfaces.

However, with the aid of these known printing devices, profiled strips with uneven contours in cross-section cannot be printed with comparable quality, because with an inclined position of the profiled surface to be printed relative to a reference plane perpendicular to the nozzles of the print heads, not only the distance of the profiled surfaces to the nozzles of the print heads changes, but also the size of the surface to be printed changes with the effect that the printer ink in the region of uneven contours of the profile cross-section is deposited with different density on the profiled surface to be printed despite a uniform delivery of the ink droplets, resulting in visually striking differences, for example in the color intensity.

In order to take into account distortions resulting from a deviation of the profiled area to be printed from a flat printing area compared to a print template used for printing, it is known (EP 2 708 675 A1) to adapt the print template itself to the distortion, for example by adapting the pixel spacing, the pixel size and/or the ink application, wherein the print head is deflected beyond the profiled area, for example, and an adaptation of the ink output to the profile takes place.

In order to apply the printer ink in layers of different thicknesses, it is known (EP 2 208 542 A1) to control the digital print heads via a control device in the sense of a different ink delivery or a different relative speed, depending on a detected surface profile, which not only entails complex measuring and control measures, but also requires a relative movement of the print head with respect to the profiled surfaces transverse to the longitudinal direction of the profiled strip when used on profiled strips.

### SUMMARY OF THE INVENTION

The invention is thus based on the object of designing a method for digitally printing a profiled strip in such a way that profiled strips which have an uneven contour can also be printed with good quality in the area of curved contours with comparatively little control effort.

Based on a method of the type described at the beginning, the invention solves the problem posed in such a way that individual contour portions are assigned reference planes by means of an evaluation program on the basis of data reproducing the contour of the profiled strip in the printing area, that the print heads are aligned with respect to these reference planes and that the nozzles of the aligned print heads are controlled with respect to the ink delivery with correction values taking into account the deviation of the respective contour portion from the reference plane.

Since, as a result of these measures, only a relative movement between the print heads and the profiled strip in its longitudinal direction is required for the printing process, the tracking of the print heads parallel to the curvature, which is otherwise required for printing curved surfaces, with the necessary control effort, is not necessary. Nevertheless, deviations from flat sections occurring in the contour of the profiled strip can be taken into account in a comparatively simple manner if reference planes are assigned to individual contour portions of the profile contour in the area to be printed and the print heads are aligned with respect to these reference planes. In the area of straight contour portions, the reference planes preferably coincide with these sections, whereas in the case of curved contour courses, the aim is generally to have a reference plane adapted to the curved contour course in such a way that a largely uniform distance range can be maintained between the reference plane and the contour course. When the print heads are aligned with respect to these reference planes, the printing conditions which change with these different distances and with the contour courses caused thereby can be taken into account by a corresponding change in the size, the speed and/or the frequency of the ink droplets ejected from the nozzles of the print heads. If the density of the applied ink droplets on a longitudinal strip of the profiled strip which is inclined with respect to the reference plane due to the contour course is to correspond to the droplet density on the reference plane, the amount of ink ejected from the nozzles associated with this inclined contour portion must be increased. This correction value depends on the geometric position of the contour portion relative to the reference plane and can therefore be determined by means of a corresponding evaluation program in order to apply these position-dependent correction values to the nozzle control, which depends on a print template, so that a print image largely corresponding to the print template is produced on the profiled strip, even in the region of curved contour portions. The reference planes adapted to the profile contour can be determined by means of digital data which reproduce the contour of the profiled strip at least in the region of the longitudinal strips to be printed, with the aid of a comparatively simple evaluation program, and can form the basis for the alignment of the nozzle heads, wherein corresponding position coordinates can be output via the evaluation program for the alignment of the nozzle heads.

Although, with regard to the printing process, only the relative movement between the print heads and the profiled strip to be printed is important, more favorable design conditions are obtained, particularly for longer profiled strips, if the print heads are not moved relative to the stationary profiled strip, but the profiled strip is guided past the stationary print heads. The print heads can be aligned in this case with respect to the reference planes in accordance with the position coordinates determined with the aid of the evaluation program by displacement in a plane perpendicular to the longitudinal direction of the profiled strip and rotation about an axis parallel to the longitudinal direction before the profiled strip is moved past the print heads, which are held stationary during the printing process, for printing.

To carry out such a method, a device can be assumed, having a longitudinal guide for the profiled strip to be printed, having digital print heads which can be displaced independently of one another with the aid of actuating drives along two coordinate axes extending in a plane perpendicular to the longitudinal guide of the profiled strip and can be rotated about an axis parallel to the longitudinal guide, and having a control device for acting on the nozzles of the print heads with regard to an ink delivery as a function of a print template. It must be ensured, however, that in an evaluation unit reference planes are assigned to individual contour portions on the basis of input data reproducing the contour of the profiled strip in the printing area, and that the nominal coordinates of the reference position of the print heads relative to these reference planes, which is predetermined by the program, are determined, that the actuating drives for the print heads can be driven with the nominal coordinates of the reference position, and that the control device for the nozzle actuation is acted upon by a correction variable for the ink delivery which takes into account the deviation of the respective contour portion from the reference plane.

By applying the target coordinates determined by the program to the actuators for aligning the print heads with respect to the profiled strip, the print heads can be brought into the intended reference position in a simple manner and held in this reference position for the printing process.

### BRIEF DESCRIPTION OF THE INVENTION

With reference to the drawing, the method according to the invention is explained in more detail, wherein:

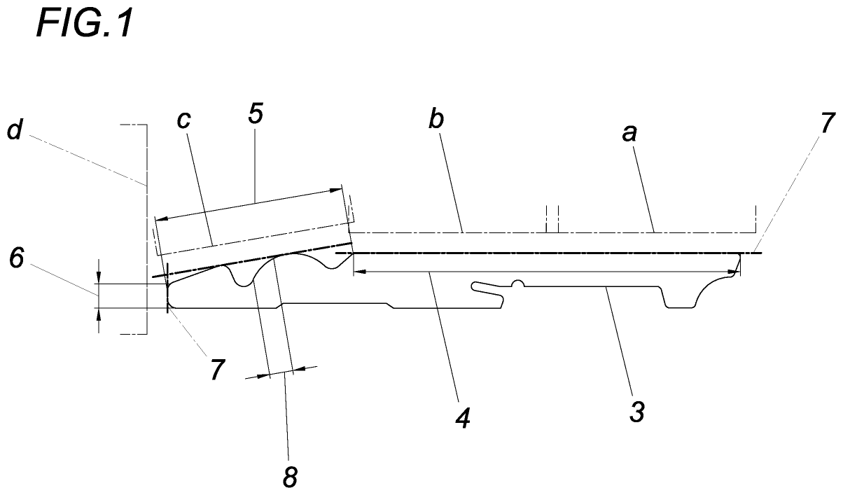

FIG. 1 shows a digitally recordable contour of a profiled strip to be printed and the reference planes assigned to individual contour portions by an evaluation program,

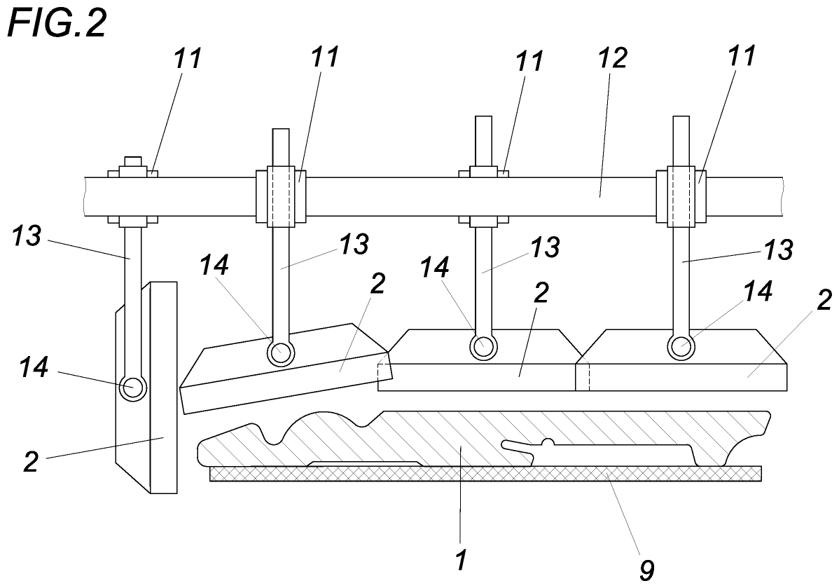

FIG. 2 shows a device according to the invention for carrying out the method in a schematic cross-section and

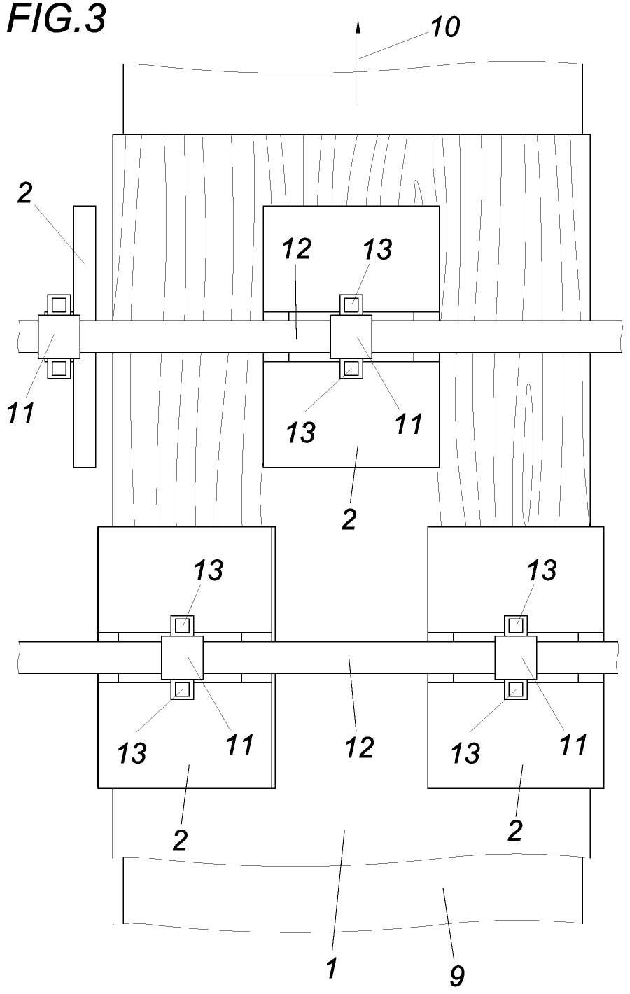

FIG. 3 shows this device in a schematic top view on a smaller scale.

### DETAILED DESCRIPTION OF THE PREFERRED EMBODIMENTS

In order to be able to print a profiled strip 1 according to the method according to the invention in accordance with a digitally stored print template, for example a wood grain, with the aid of digital print heads 2, the contour 3 of the profiled strip 1 corresponding to the profile cross-section must first be digitally recorded, for which digital drawing data are suitable. By means of an evaluation program, individual contour portions 4, 5, 6 in the area of the profiled strip 1 to be printed can be assigned reference planes 7, which are selected in such a way that the deviations of the contour course from these reference planes 7 remain limited and therefore comparatively small correction values are required for the control of the print heads 2 during printing. This means that in straight contour portions 4, 6, the reference plane 7 coincides with the contour course, as can be taken from FIG. 1. In contour portion 5, the course of which clearly deviates from a straight line, the reference plane 7 is defined over the extension length of this contour portion 5 in the sense of minimizing the distance between the contour portion 6 and the reference plane 7 associated with this contour portion 6.

If the ink droplets ejected by the nozzles of a print head do not impinge on a reference plane perpendicular to the ink jet, but on a surface inclined thereto, the droplet density on the inclined surface is lower compared to an application on the reference plane due to the larger application surface. This applies, for example, to the area 8 shown in FIG. 1, which has a considerable inclination with respect to the associated reference plane 7. This means that, compared to the print template referred to a plane, a lower ink intensity is achieved in region 8, for example, and to compensate for this error the nozzles of the associated print head 2 in region 8 are to be controlled with a correction value which ensures a correspondingly higher ink delivery in region 8, so that despite the reference of the print template to reference plane 7 an ink density corresponding to the ink density of the print template can also be ensured on the longitudinal strip of profiled strip 1 determined by region 8 of contour 3. Since the correction values can essentially be derived from the geometric assignment of the contour deviations with respect to the associated reference plane, not only suitable reference planes can be defined by a corresponding evaluation program, but also the correction values dependent thereon for controlling the nozzles of the print heads 2 can be specified.

Since the dimensions of the print heads 2 are known, a position assignment of the individual print heads 2 to the reference planes 7 can also be made with the aid of the evaluation program. Indeed, it is only necessary to assume a preferred distance of the print heads 2 from the associated reference plane in order to displace the print heads at this distance parallel to the reference plane 7 in such a way that the printing area extends over a corresponding contour portion. According to FIG. 1, the length of the contour portion 4 exceeds the printing width of a print head 2, so that two print heads 2 must be used for this contour portion 2 if the profiled strip is to be printed in one pass. The nominal position of the individual print heads in relation to the contour portions 4, 5, 6 to be printed are indicated by dashed dots in FIG. 1 and are designated a, b, c, and d, wherein it is possible to specify coordinates for each of these positions a, b, c, d which unambiguously define the position of the individual print heads 2 in relation to the profiled strip 1.

FIGS. 2 and 3 schematically illustrate a device for printing a profiled strip 1 according to the method according to the invention. According to this exemplary embodiment, the profiled strip is moved in the longitudinal direction of the profiled strip 1 past the print heads, which are held in a stationary manner during the printing process, with the aid of a conveyor device 9, for example a conveyor belt. However, in order to align the print heads 2 with respect to the profiled strip 1, the print heads 2 must be displaceable independently of one another in a plane perpendicular to the longitudinal direction 10 along two coordinate axes and must also be rotationally adjustable about an axis parallel to the longitudinal axis 10. According to the exemplary embodiment shown in FIGS. 2 and 3, this is achieved in that the print heads 2 are guided for vertical displacement in carriages 11 which are adjustable along a horizontal guide 12 aligned perpendicular to the longitudinal direction 10. Since the print heads 2 are mounted on the lifting arms 13, which are displaceable in height in the carriage 11, so as to be rotationally adjustable about an axis 14 parallel to the longitudinal direction 10, the individual print heads 2, which are offset in pairs relative to one another in the longitudinal direction, can be aligned relative to the profiled strip 1 in accordance with the respective requirements.

For this purpose, the carriages 11, the lifting arms 13 and the print heads can be provided with actuators which are acted upon by a control device. As has already been explained in connection with FIG. 1, nominal coordinates for the individual positions a, b, c, d of the print heads 2 can be provided by the evaluation program. For example, the respective coordinates of the axes 14 as well as the associated angle of rotation can be specified in order to align the print heads 2 with respect to the profiled strip in accordance with the reference positions a, b, c, d on the basis of these position coordinates, so that the control of the nozzles of the print heads 2, which is dependent on a print template, is acted upon with the correction values determined for the reference positions a, b, c, d, which permits comparatively simple consideration of curved contours. In order to take into account corners and curves, an overlapping printing area of two print heads can also be used to ensure a nominal distribution of the ink droplets in these areas.

1. A method for digitally printing a profiled strip said method comprising:
aligning a plurality of digital print heads with respect to contour portions of the profiled strip in an aligned reference position;
moving the digital print heads in the aligned reference position relative to the profiled strip along longitudinal strips of the profiled strip determined by contour portions of the profiled strip at a predetermined distance;
controlling nozzles of the print heads with respect to ink delivery as a function of a print template;
assigning to each of the contour portions respective reference planes using an evaluation program on the basis of data corresponding to contour of the profiled strip in a printing area;
aligning the print heads with respect to the reference planes; and
controlling the nozzles of the aligned print heads with respect to the ink delivery based on a correction value derived from a deviation of the respective contour portion from the reference planes.

2. The method according to claim 1, wherein the print heads are aligned with respect to the reference planes in accordance with position coordinates determined using the evaluation program by a displacement in a plane perpendicular to a longitudinal direction of the profiled strip and a rotation about an axis parallel to the longitudinal direction before the profiled strip is moved past the print heads, which are held stationary during the printing process for printing.

3. A device for digitally printing a profiled strip, said device comprising:
a longitudinal guide guiding the profiled strip to be printed;
digital print heads that are supported so as to be displaced independently of one another by actuators along two coordinate axes extending in a plane perpendicular to the longitudinal guide of the profiled strip and so as to be rotated about an axis parallel to the longitudinal guide;
a control device acting on the nozzles of the print heads with respect to an ink delivery as a function of a print template; and
an evaluation unit assigning respective reference planes to each of the contour portions of the profiled strip based on input data corresponding to a contour of the profiled strip in a printing area, and determining nominal coordinates of a reference position of the print heads that is predetermined by a program, with respect to reference planes,
wherein the actuators for the print heads are controlled with the nominal coordinates of the reference position; and
wherein the control device for nozzle actuation is acted upon by a correction value for the ink delivery that takes into account a deviation of the respective contour portion from the reference plane.
